(19) United States
(12) Patent Application Publication
(10) Pub. No.: US 2005/0228825 A1
(43) Pub. Date: Oct. 13, 2005

(54) Method for managing knowledge from the toolbar of a browser

(76) Inventor: Tsun-Yi Yang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/817,911

(22) Filed: Apr. 6, 2004

(51) Int. Cl. G06F 17/00

(52) U.S. Cl. 707/104.1

(57) ABSTRACT

A method for managing knowledge from the toolbar of a browser mainly adds a knowledge management tool on the toolbar of a browser. The knowledge management tool enables a user to edit the texts or pictures of the web page directly, and to classify the edited or browsed only web page using meaningful keywords or annotation, and to save the web page into a server to facilitate other users to access conveniently thereafter without need to search again for the URL (uniform resource locator) of the web page. Thus, others can share the web pages stored in the server, obtained by the former having browsed from the Internet.

### BACKGROUND OF THE INVENTION

1. Field of the Invention

The present invention relates to a method for managing knowledge from the toolbar of a browser, and particularly to a method for managing knowledge from the toolbar of a browser which adds a knowledge management tool on a browser such that a user can edit the texts or pictures of a web page directly, classify the web page according to the content of the web page, and save the web page in a server, so as to share the web page with others.

2. Description of the Prior Art

As in the e-generation, using a browser to surfing the Internet become a part of modem livelihood. Due to the information provided from the Internet so diverse and abundant that any question can be answered by enquiring solutions through the Internet.

During browsing the Internet, usually, there is a need to preserve useful data of technology or news whether found by a specific searching or read from a certain specified website. Generally, the common manner for preserving a web page is to use the book-marking function of a browser to record the web page in the browser or saving the web page directly into the hard disk such that the web page can be opened anytime to prevent the web page removed by the original website. But, the web page preserved by book-marking are stored only in a computer and can not have it shared with other. If saved in the hard disk, although the web page is editable, additional actions and work are needed to have it shared with others. Accordingly, although available to preserve the web page, the conventional manner can not accomplish the above two functions at the same time via a single interface, and does not provide a function for the user to record additional knowledge information annotated according to the content of the web page, thus improvement is necessary.

Accordingly, it can be seen that the above-described conventional products still has many drawbacks, and are not designed well, and need to be improved badly.

In view of disadvantages derived from the above-described conventional browser, the present inventor had devoted to improve and innovate, and, after studying intensively for years, developed successfully a method for managing knowledge from the toolbar of a browser according to the invention.

### SUMMARY OF THE INVENTION

The object of the present invention is to provide a method for managing knowledge from the toolbar of a browser which enables a user to directly edit the texts or pictures of a web page; after edited, the web page is classified and then saved in a server to form a knowledge base facilitating other users to access anytime.

The further object of the present invention is to provide a method for managing knowledge from the toolbar of a browser which can transform the browsed and searched data into more valuable knowledge and share the knowledge with everybody.

The method for managing knowledge from the toolbar of a browser according to the invention capable of achieving the above mentioned objects mainly adds a knowledge management tool on a browser toolbar; via the knowledge management tool, there is provided a single interface for accomplishing tasks such as editing, annotating, classifying, and storing a web page, and the likes. For example, after using a search engine to search web pages about “software claim”, the user may find only a few web page the user truly needs in the thousands of searched results. Now, the user can start the knowledge management tool from the browser and activate the edit function to edit or annotate the texts and pictures of the web page, and then choose an appropriate set category in the knowledge management tool and adding keywords such as “software claim”, “for which case”, etc., and then click the save button to store the web page into the knowledge base, so the user or co-workers can retrieve desired data just from the knowledge base and need not to waste time searching again for the data from the thousands of web pages retrieved from the search engine.

These features and advantages of the present invention will be fully understood and appreciated from the following detailed description of the accompanying Drawings.

### BRIEF DESCRIPTION OF THE DRAWINGS

FIG. 1 is the interface diagram of the knowledge management function of the method for managing knowledge from the toolbar of a browser according to the present invention;

FIG. 2 is the interface diagram of the content annotating function of the method for managing knowledge from the toolbar of a browser according to the present invention;

FIG. 3 is the interface diagram of the program setting function of the method for managing knowledge from the toolbar of a browser according to the present invention;

FIG. 4 is the operation flowchart of the method for managing knowledge from the toolbar of a browser according to the present invention; and

FIG. 5 is the flow chart of knowledge retrieval of the method for managing knowledge from the toolbar of a browser of the present invention;

### DETAILED DESCRIPTION OF THE PREFERRED EMBODIMENT

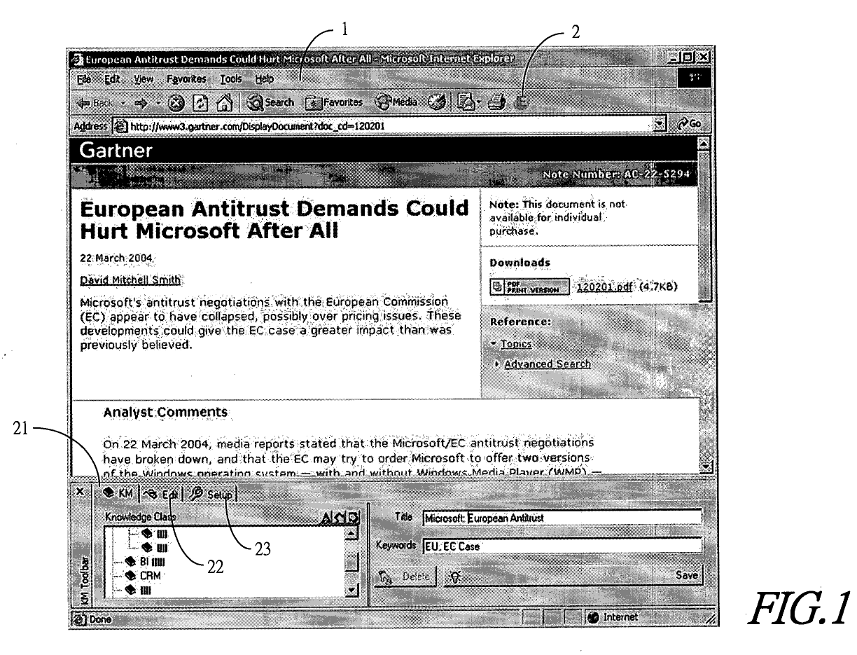

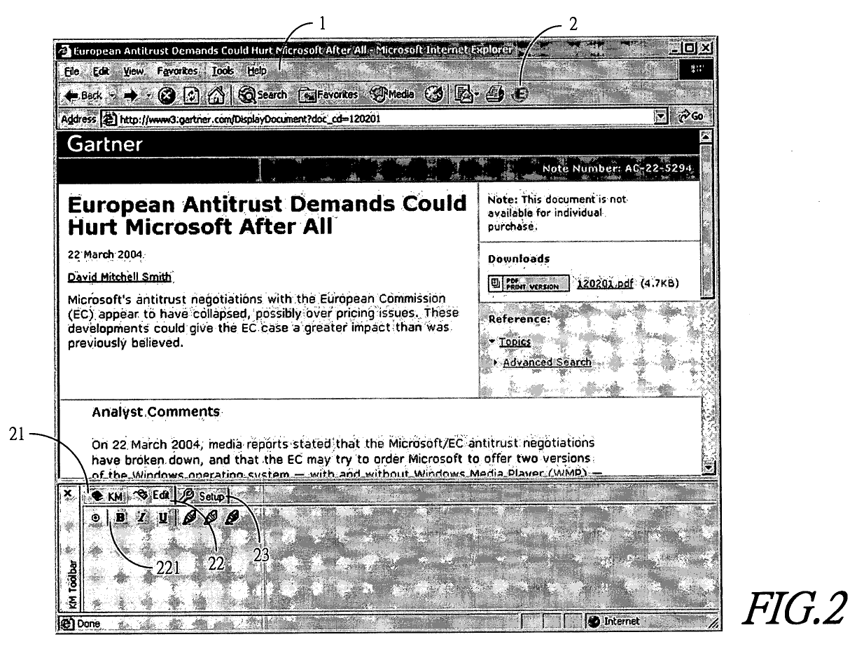

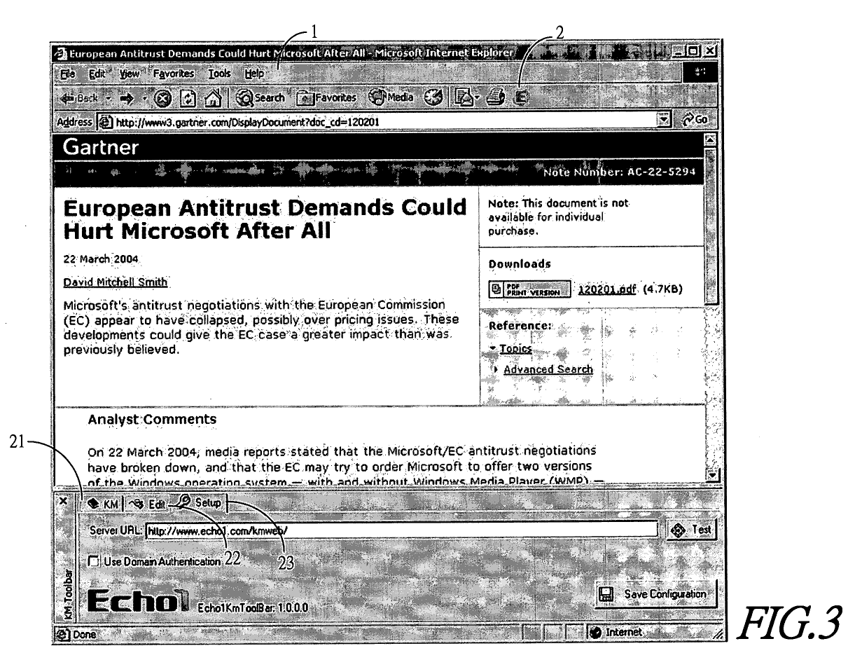

Please referring to FIG. 1-3, the operation interface diagrams provided by the method for managing knowledge from the toolbar of a browser which mainly adds a knowledge management tool 2 on the toolbar 1 of a browser. The knowledge management tool 2 comprises a knowledge management function 21, a content annotating function 22, and a program setting function 23, wherein, as shown in FIG. 1, the knowledge management function 21 can classify a web page considered to be preserved according to a classification, using a specific title and keywords as a category and subsequently saved in the preset server to achieve the object of managing knowledge. As shown in FIG. 2, the content annotating function 22 comprises a toolbar 221 for editing of a web page, such as modifying or annotating the texts and pictures thereof. Via the toolbar 221, the user can edit the texts and pictures in the web page directly. After accomplished the editing, the web page can be classified and subsequently saved in the server via the knowledge management function 21. As shown in FIG. 3, the program setting function 23 can set the URL (uniform resource locator) of the server and save the URL in the system such that the web page classified by the knowledge management function 21 can be stored into the set server, thus the server forms a knowledge database for sharing the browsed results with others, so that there is no need for the user to search for the desired information from the search engine again thereafter.

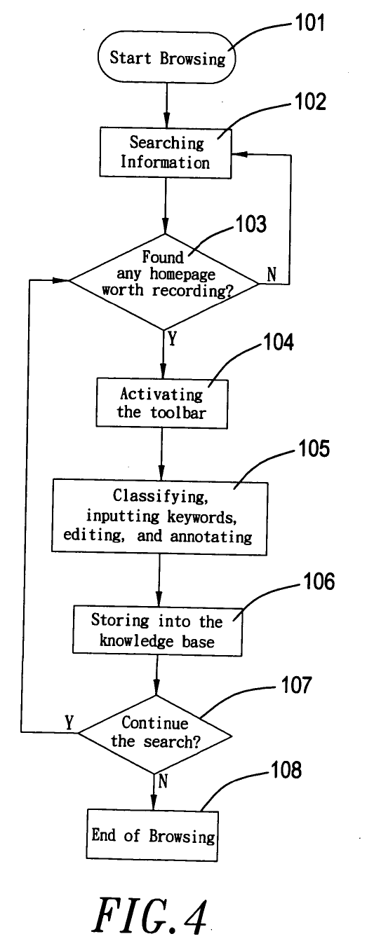

Further referring to FIG. 4, which is the operation flowchart of the present invention. While the user starts 101 to browse a web page on the Internet through a browser, firstly needs to retrieve 102 information from a search engine and then determines 103 if the searched web page worth recording. If not, continues the search 102. If yes, activates 104 the knowledge management tool in the browser, to perform 105 the modification and annotation of the web page via the content annotating function of the knowledge management tool, and then inputs a title and keywords to classify the web page, and save 106 the classified web page into a server. Finally, determines 107 if continuing the web page search. If not, end the browsing 108. If yes, determines 103 if any found web page worth recording.

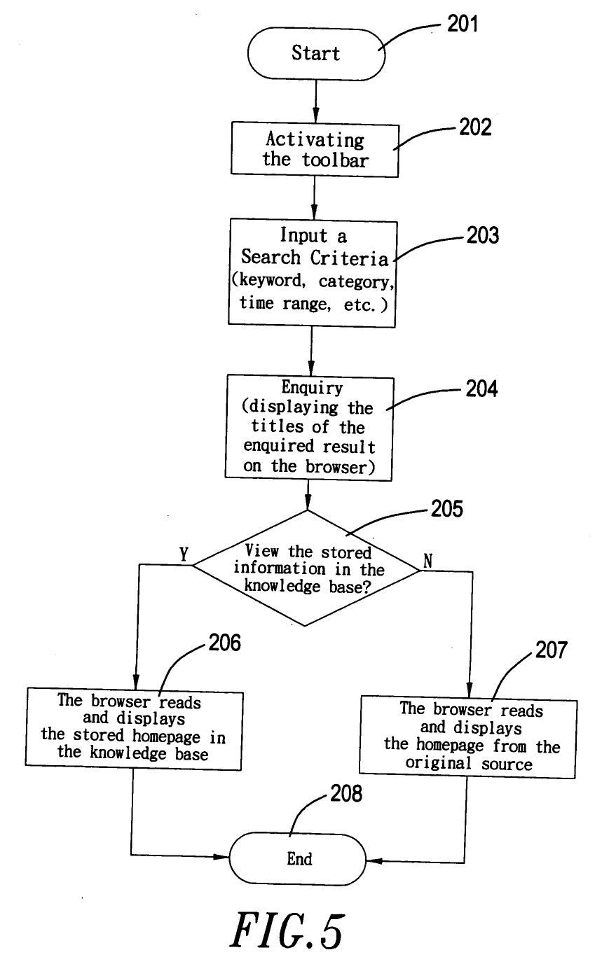

Referring to FIG. 5, which is the flow chart of knowledge retrieval of the invention. As the flow starts 201, the user can directly activate 202 the knowledge management tool on the browser, input 203 the search criteria with input condition can be keyword, classification title, time range, and the likes, such that the browser will display the enquired web pages for the user 204. And then, the user can determine 205 whether searching the data stored in the server again. If yes, the browser will read and display the web pages stored in the server 206 and ends the search 208. If not, the browser will read and display the web page from the original source 207 and ends the search 208.

As compared with other conventional techniques, the method for managing knowledge from the toolbar of a browser according to the present invention has following advantages:
1. The present invention adds a knowledge management tool on a browser that a user can directly edit the texts or pictures of the web page; after accomplishing the editing, the user can classify and then saved the web page in a server to form a knowledge base that facilitates any user to access anytime.
2. The present invention can transform the browsed and searched data into more valuable knowledge and share the knowledge with other colleagues, thus can promote the overall work efficiency.
3. The present invention provides a single interface for a user to accomplish the tasks of a web page in the same time, such as editing, classifying, saving, etc., to achieve the object of optimizing the knowledge management.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. A method for managing knowledge from the toolbar of a browser, which mainly adds a knowledge management tool on the toolbar of a browser to enable a user to directly edit a web page, such as modifying or annotating the texts or pictures of the web page and the likes, and to classify the edited or browsed only web page using a meaningful title and keywords, and to save the web page into a preset server to form a knowledge base in the server, and thus anyone can retrieve the desired information from the knowledge base.

2. The method of claim 1, wherein the knowledge management tool comprises a knowledge management function , a content annotating function, and a program setting function.

3. The method of claim 2, wherein the knowledge management function can enable the user to classify a web page considered to be preserved according to a classification method, using a specific title and keywords as a category, and subsequently save in the preset server.

4. The method of claim 1, wherein the content annotating function comprises a toolbar for editing the texts or pictures of a web page.

5. The method of claim 1, wherein the program setting function can enable the user to set the URL (uniform resource locator) of a server and save the set URL in the system such that the web page classified by the knowledge management function can be stored into the set server.
